(19) United States
(12) Patent Application Publication
(10) Pub. No.: US 2006/0278836 A1
(43) Pub. Date: Dec. 14, 2006

(54) Valve mechanism for a plumbing device

(76) Inventor: Raymond A. Vincent, Plymouth, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/151,958

(22) Filed: Jun. 14, 2005

(51) Int. Cl. F16K 31/02

(52) U.S. Cl. 251/129.04

(57) ABSTRACT

A valve mechanism for a plumbing device includes a valve for a plumbing conduit. The valve is movable between an open position and a closed position. An actuator moves the valve between the open position and the closed position. When the plumbing device malfunctions the valve moves to the closed position.

### BACKGROUND OF THE INVENTION

The present invention relates generally to a flow restricting valve mechanism and, more particularly, to a mechanical shut off device for an automatic water faucet.

Plumbing devices using valves to restrict and permit flow, such as automatic water faucets, are known. These plumbing devices may rely on detecting an object, such as a user's hands, to trigger an actuator to open the valve permitting water flow through the faucet. After the user's hands are removed, the actuator moves the valve to a flow restricting position. The flow restricting position can prevent flow though the automatic water faucet.

These plumbing devices typically rely on battery-powered actuators to manipulate the valve. Accordingly, in the event of a battery failure or other actuator malfunction, the valve may remain in a flow permitting position. This situation may result in wasted water or even flooding.

Therefore, there exists a need in the art to provide a mechanical shut off device for an automatic water faucet.

### SUMMARY OF THE INVENTION

The present invention provides a valve mechanism for a plumbing device. The present invention includes a movable valve, an actuator and a plumbing conduit. When powered, the actuator moves the valve between a flow restricting position and a flow permitting position. Under normal operation, the actuator moves the valve between these positions. However, in the event of a malfunction, such as a battery failure, the valve moves to the flow restricting position and may do so without relying on the powered actuator. Thus, a malfunction triggers the valve to move to the flow restricting position.

The invention may have a spring, which is used to move the valve in the event of a malfunction independent of the battery. The spring is more relaxed when the valve is in the flow restricting position, than when the valve is in the flow permitting position. Therefore, as the valve moves from the flow restricting position to the flow permitting position, the spring becomes less relaxed. If a malfunction occurs, the spring moves the valve to the flow restricting position. Under normal operation, the actuator moves the valve to the flow restricting position.

The invention may be used in an automatic water faucet. The actuators in automatic water faucets are typically battery powered. Automatic water faucets usually contain an object detection system triggering the actuator to move the valve. Generally, the actuator will utilize planetary gears to move the valve. The actuator also moves the spring between a relaxed position and a less relaxed position. If, when triggered, the actuator cannot fully actuate the valve, such as during a battery failure, the spring returns the valve to the flow restricting position.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 is a schematic of the plumbing device when the valve is in a flow permitting position.

FIG. 2 is a schematic of the plumbing device when the valve is in a flow restricting position.

FIG. 3 is a schematic of the plumbing device after detecting a malfunction.

### DETAILED DESCRIPTION OF THE PREFERRED EMBODIMENT

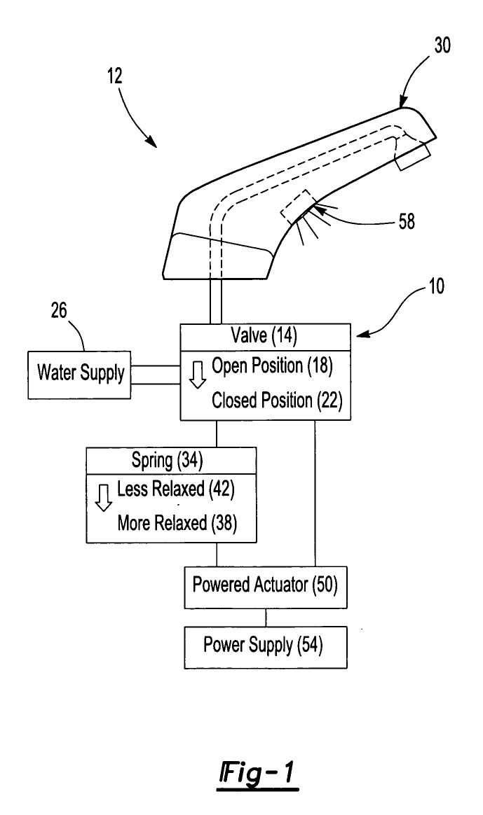

Referring to FIG. 1, a schematic depicting the operation of a valve mechanism 10 for a plumbing device 12 is illustrated. The schematic depicts a valve 14 in communication with an automatic water faucet 30. Although the present invention is described in terms of an automatic water faucet 30, it should be recognized that other plumbing devices 12 may employ configurations similar to the one described herein.

FIG. 1 illustrates the position of a spring 34 when the valve 14 is in a closed position 22, a flow restricting position. The valve 14 may be of the sliding variety such that the valve 14 will rotate into the closed position 22. A sliding type valve 14 lessens the force necessary to restrict the flow through the automatic water faucet 30.

The valve 14 in the closed position 22 prevents water from flowing from a water supply 26 to the automatic water faucet 30. Generally, the flow rate through an automatic water faucet 30 is less than 2 gallons per minute. However, the present invention may also be used in higher flow rate environments, such as Roman tubs or bathtubs, where flow rates may exceed 5 gallons per minute. In addition, flow rates through plumbing devices 12 may be controlled by mechanisms upstream or downstream from the valve 14.

The spring 34 is in communication with the valve 14. When the valve 14 is in the closed position 22 the spring 34 maintains a more relaxed position 38. A power supply 54 powers a powered actuator 50. Under normal operation, the powered actuator 50 moves the valve 14 between the closed position 22 and an open position 18, a flow permitting position.

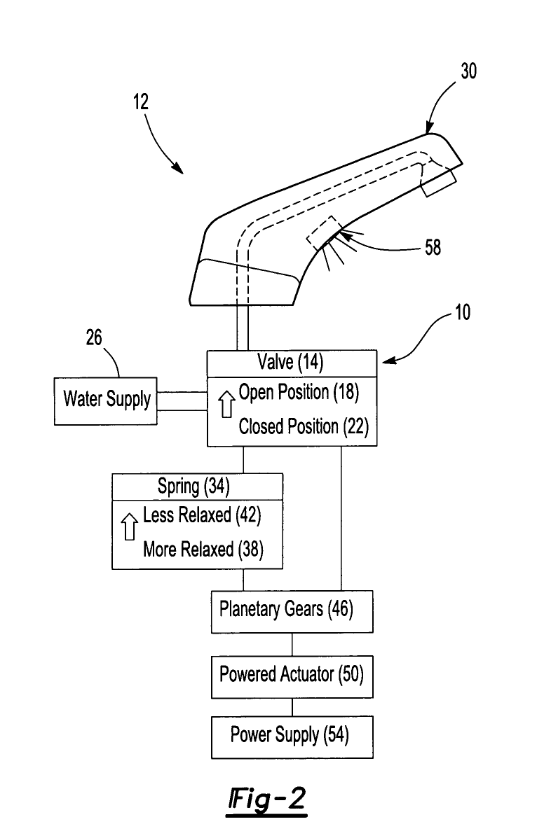

An object detection system 58 can trigger the valve 14 to move from the closed position 22 to the open position 18. When the object detection system 58 detects an object, such as a user's hands, the powered actuator 50 moves the valve 14 to the open position 18, as shown in FIG. 2. When the object is no longer detected, the powered actuator 50 returns the valve 14 to the closed position 22, as shown in FIG. 1. The powered actuator 50 also moves the spring 34 from the more relaxed position 38 of FIG. 1 to a less relaxed position 42 of FIG. 2. Thus, the valve 14 moves from the closed position 22, as shown in FIG. 1, to the open position 18, as shown in FIG. 2 while the spring moves from the more relaxed position 38 to the less relaxed position 42 during normal operation.

Referring again to FIG. 2, a set of planetary gears 46 may move the spring 34 and the valve 14. The powered actuator 50 drives the planetary gears 46, although other types of a low force operating mechanisms or commercially available devices may be used. Typically, the planetary gear set 46 comprises a three-stage gear set. The planetary gears 46 may rotate the valve 14 between the closed position 22 and the open position 18, a position permitting flow.

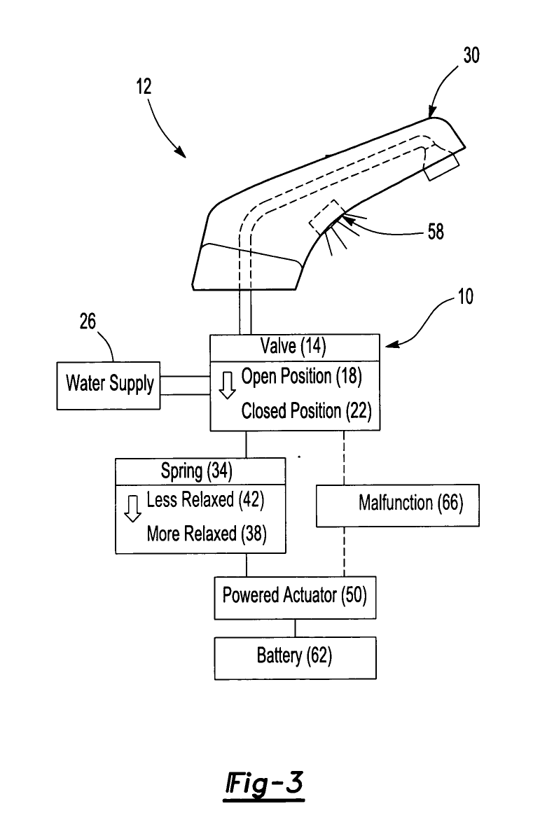

The default position of the valve 14 is the closed position 22, and the valve 14 will move to the closed position 22 after a malfunction 66, such as a control circuit failure, in the plumbing device 12. FIG. 3 schematically depicts the positions of the spring 34 and the valve 14 after the malfunction 66, in the plumbing device 12. As shown, the spring 34 returns to the more relaxed position 38, the default position of the spring 34 and, in so doing, moves the valve 14 to the closed position 22. The spring 34 does not rely on the powered actuator 50 and the planetary gears 46 to move the valve 14 when the malfunction 66 is detected. Operating the plumbing device 12 in this manner prevents the valve 14 from maintaining the open position 18 upon the malfunction 66 in the plumbing device 12.

FIG. 3 also shows an alternative power supply 54, a battery 62. The battery 62 is frequently used as a power source for powered actuators 50 in automatic water faucets 30. Failure of the battery 62 is the type of malfunction 66 capable of triggering moving the valve 14 to the closed position 22. There are many advantages to moving the valve 14 to the closed position 22 upon a malfunction 66 in the automatic water faucet 30. For example, as the valve 14 moves to the closed position 22 when the batteries 62 fail, there is minimal risk of flooding or wasting water.

It should be understood that various alternatives to the embodiments of the invention described herein may be employed in practicing the invention. One of ordinary skill in the art would recognize that certain modifications are within the scope of this invention. The following claims define the invention and should be studied to determine the true scope and content of this invention.

1. A valve mechanism for a plumbing device, comprising:
a valve for a plumbing conduit, said valve movable between a flow restricting position and a flow permitting position; and
an actuator operative to move said valve from said flow restricting position to said flow permitting position, and selectively operative to move said valve from said flow permitting position to said flow restricting position upon a malfunction of the plumbing device.

2. The valve mechanism as described in claim 1, wherein a power loss to said plumbing device is a condition of malfunction.

3. The valve mechanism as described in claim 1, further comprising a biasing device operative to bias said valve towards said flow restricting position.

4. The valve mechanism as described in claim 3, wherein said biasing device is a spring.

5. The valve mechanism as described in claim 4, wherein said actuator moves said spring to a less relaxed position while moving said valve from a flow restricting position to a flow permitting position.

6. The valve mechanism as described in claim 1, wherein said valve acts as an automatic flow shut-off for a plumbing device.

7. The valve mechanism as described in claim 1, wherein said plumbing conduit is in fluid communication with an automatic water faucet.

8. The valve mechanism of claim 1, wherein said actuator is a powered actuator.

9. The valve mechanism of claim 8, wherein said powered actuator is a battery powered actuator.

10. A valve mechanism for a plumbing device, comprising:
a valve movable between a flow restricting position and a flow permitting position;
an actuator operative to move said valve between said flow restricting position and said flow permitting position; and
a biasing member operative to bias said valve towards said flow restricting position.

11. The valve mechanism for a plumbing device as described in claim 10, wherein said biasing member positions said valve in said flow restricting position upon a malfunction of the plumbing device.

12. The valve mechanism as described in claim 10, wherein said biasing member is a spring.

13. The valve mechanism as described in claim 12, wherein said biasing member and valve act as an automatic flow shut-off device.

14. The valve mechanism as described in claim 12, wherein said actuator moves said spring to a less relaxed position while moving said valve from a flow restricting position to a flow permitting position.

15. The valve mechanism as described in claim 10, wherein said actuator is a powered actuator.

16. The valve mechanism of claim 15, wherein said powered actuator is battery powered.

17. A method of controlling flow in a plumbing device, comprising the steps of:
(a) positioning a valve to restrict flow;
(b) adjusting the valve to permit flow;
(c) repositioning the valve to restrict flow in the event of a malfunction.

18. A method as described in claim 17, wherein the valve is biased to restrict flow in the event of a malfunction.

19. A method as described in claim 18, wherein said step of biasing said valve further comprises the step of moving a spring from a more relaxed position to a less relaxed position.
